(19) United States
(12) Patent Application Publication
(10) Pub. No.: US 2013/0133397 A1
(43) Pub. Date: May 30, 2013

(54) GYRO SENSOR OFFSET AUTOMATIC CORRECTING CIRCUIT, GYRO SENSOR SYSTEM AND METHOD FOR AUTOMATICALLY CORRECTING OFFSET OF GYRO SENSOR

(71) Applicant: Samsung Electro-Mechanics Co., Ltd., Gyeonggi-do (KR)

(72) Inventors: Sung Tae KIM, Gyeonggi-do (KR); Chang Hyun Kim, Geonggi-do (KR)

(73) Assignee: Samsung Electro-Mechanics Co., Ltd., Gyeonggi-do (KR)

(21) Appl. No.: 13/689,103

(22) Filed: Nov. 29, 2012

(30) Foreign Application Priority Data
Nov. 30, 2011 (KR) 10-2011-0126987

(51) Int. Cl. G01C 25/00

(52) U.S. Cl. CPC G01C 25/00
USPC 73/1.77

(57) ABSTRACT

Disclosed herein are a gyro sensor offset automatic correcting circuit, a gyro sensor system, and a method for automatically correcting offset of a gyro sensor. There is provided a gyro sensor offset automatic correcting circuit, including: a signal gain controller receiving and amplifying output signals of each sensor electrode, while removing at least some of offset by a driving signal component included in each output signal by controlling a variable resistor(s); and an amplitude detector detecting the output signal of the signal gain controller to control the variable resistor(s) so that the output signal of the signal gain controller is maintained within a predetermined range. Further, there are provided a gyro sensor system including the gyro sensor offset automatic correcting circuit and a method for automatically correcting offset of a gyro sensor.

### CROSS REFERENCE(S) TO RELATED APPLICATIONS

This application claims the benefit under 35 U.S.C. Section 119 of Korean Patent Application Serial No. 10-2011-0126987, entitled “Gyro Sensor Offset Automatic Correcting Circuit, Gyro Sensor System and Method for Automatically Correcting Offset of Gyro Sensor” filed on Nov. 30, 2011, which is hereby incorporated by reference in its entirety into this application.

### BACKGROUND OF THE INVENTION

1. Technical Field

The present invention relates to a gyro sensor offset automatic correcting circuit, a gyro sensor system and a method for automatically correcting offset of the gyro sensor. More particularly, the present invention relates to a gyro sensor offset automatic correcting circuit, a gyro sensor system and a method for automatically correcting offset of the gyro sensor that minimize offset by a driving signal component by controlling a gain of a sensor output signal.

2. Description of the Related Art

A gyro sensor as a sensor detecting an angular velocity is generally used for attitude control of an airplane, a rocket, a robot, and the like, correction of a hand shake of a camera, binoculars, and the like, a vehicle sliding and rotation preventing system, a navigation, and the like. In recent years, the gyro sensor has been mounted on even a smart phone, and as a result, the utilization thereof has been very high.

The gyro sensor includes various types such as rotating, vibrating, fluid type, optical gyro sensors, and the like and the vibrating gyro sensor is generally used as a mobile product at present. The vibrating sensor may be largely classified into two types and one may be classified into a piezoelectric type and a capacitive type. Presently, the vibrating sensor generally used is mostly vibrating sensors having a capacitive type comb structure but also includes some piezoelectric type sensors. The vibrating gyro sensor generally detects the magnitude of the angular velocity by coriolis force.

Since the driving signal component in an output signal in the gyro sensor is an in-phase signal and a gyro signal component is a differential signal, only a gyro signal should remain when passing through a differential amplifier. However, in general, the gyro sensor is manufactured by using a micro electro mechanical (MEMS) process and even though the gyro sensor is manufactured with precision, minute deviation is generated and this deviation causes offset of the output signal.

In this case, when a gain of the differential amplifier is large, a signal may be saturated by AC offset. Further, when the gain is small due to the saturation, sensitivity may deteriorate.

### SUMMARY OF THE INVENTION

An object of the present invention is to provide a technology for automatically correcting offset that removes or minimizes a driving signal component included in a sensor output by adjusting the magnitude of a driving signal to be maximally similar in order to prevent saturation depending on amplification of an output signal of a sensor.

According to an exemplary embodiment of the present invention, there is provided a gyro sensor offset automatic correcting circuit, including: a signal gain controller receiving and amplifying output signals of each sensor electrode, while removing at least some of offset by a driving signal component included in each output signal by controlling a variable resistor(s); and an amplitude detector detecting the output signal of the signal gain controller to control the variable resistor(s) so that the output signal of the signal gain controller is maintained within a predetermined range.

In another example of the present invention, the signal gain controller may include: a gain adjusting unit receiving the output signals of each sensor electrode and amplifying the received output signal to have a gain adjusted by controlling the variable resistor(s); and a differential amplifying unit receiving the output of the gain adjusting unit and differentially amplifying the received output to remove at least some of the offset by the driving signal component.

In this case, in one example, the gain adjusting unit may include first and second gain amplifiers receiving the output signals of each sensor electrode through inversion terminals, and the first and second gain amplifiers may perform non-inversion amplification of the output signals of each sensor electrode according to the variable resistors connected to non-inversion terminals.

Further, in one example, the gain adjusting unit may include first and second gain amplifiers receiving the output signals of each sensor electrode through the inversion terminals, and the first and second gain amplifiers may perform non-inversion amplification of the output signals of the sensor electrodes, while the variable resistor is connected to the non-inversion terminal of any one of the first and second gain amplifiers.

In another example of the present invention, the variable resistor(s) may be a variable resistor(s) using switches which are digitally trimmable.

According to one example, the amplitude detector may include a comparator and when the output signal of the signal gain controller is equal to or more than a predetermined first level or equal to or less than a predetermined second level, the amplitude detector generates a signal for controlling the variable resistor(s) so that the output signal of the signal gain controller is maintained within the predetermined range.

In this case, in one example, the amplitude detector may include: a comparator comparing the output signal of the signal gain controller with the first level or the second level; and a variable resistor controlling unit generating the signal for controlling the variable resistor(s) in accordance with the output of the comparator.

According to one example, the sensor electrode may be an electrode of a piezoelectric type or capacitive type vibrating gyro sensor.

Further, in one example, the signal gain controller may transmit the amplified signal to an analog signal processor that separates a gyro signal component and removes the driving signal component.

According to another exemplary embodiment of the present invention, there is provided a gyro sensor system, including: a gyro sensor outputting sensor signals depending on movement of an objective through a plurality of sensor electrodes by receiving a driving signal; the gyro sensor offset automatic correcting circuit as described above, receiving and amplifying output signals of each sensor electrode of the gyro sensor, while outputting an output signal within a predetermined range; an analog signal processor separating a gyro signal component and removing a driving signal component by receiving an output signal of a signal gain controller of the offset automatic correcting circuit; and an analog-to-digital converter converting the gyro signal separated in the analog signal processor into a digital signal.

In another example of another exemplary embodiment, the gyro sensor system may further include an amplifier amplifying the gyro signal component separated in the analog signal processor between the analog signal processor and the analog-to-digital converter.

In one example, the analog signal processor may include: a demodulator separating the driving signal component and the gyro signal component by receiving the output signal of the signal gain controller of the offset automatic correcting circuit; and a low-pass filter removing the driving signal component separated in the demodulator.

According to another example, the gyro sensor system may further include a demodulation signal applier applying a demodulation signal for separating the gyro signal in the analog signal processor to the analog signal processor.

Next, according to yet another exemplary embodiment of the present invention, there is provided a method for automatically correcting offset of a gyro sensor, including: controlling a signal gain to remove at least some of offset by a driving signal component included in each output signal by controlling a variable resistor(s), while receiving and amplifying the output signals of each sensor electrode; and controlling the variable resistor(s) so that the detected output signal is maintained within a predetermined range by detecting the signal amplified and outputted in the controlling of the signal gain.

In another example of yet another exemplary embodiment, the controlling of the signal gain may include: amplifying a gain to have a gain adjusted by controlling the variable resistor(s) by receiving the output signals of each sensor electrode; and receiving a signal amplified in the amplifying of the gain and differentially amplifying the received signal to remove at least some of the offset by the driving signal component.

In this case, in one example, in the amplifying of the gain, non-inversion amplification of the output signals of each sensor electrode may be performed in accordance with the variable resistors connected to non-inversion terminals by first and second gain amplifiers receiving the output signals of the sensor electrodes through inversion terminals.

Further, according to one example, in the amplifying of the gain, non-inversion amplification of the output signals of each sensor electrode may be performed by the first and second gain amplifiers receiving the output signals of the sensor electrodes through the inversion terminals, while the variable resistor is connected to a non-inversion terminal of any one of the first and second gain amplifiers.

In one example, in the controlling of the variable resistor(s), whether the output signal from the controlling of the signal gain is equal to or more than a predetermined first level or equal to or less than a predetermined second level may be judged by a comparator and a signal for controlling the variable resistor(s) is generated according to the judgment result so that the output signal from the controlling of the signal gain is maintained within the predetermined range.

According to another example, the method may further include separating a gyro signal component from the signal amplified in the controlling of the signal gain and removing the driving signal component.

### BRIEF DESCRIPTION OF THE DRAWINGS

FIG. 1 is a schematic block diagram of a gyro sensor offset automatic correcting circuit according to an exemplary embodiment of the present invention;

FIG. 2 is a schematic circuit diagram of a gyro sensor offset automatic correcting circuit according to an exemplary embodiment of the present invention;

FIG. 3 is a schematic circuit diagram of a gyro sensor offset automatic correcting circuit according to another exemplary embodiment of the present invention;

FIG. 4 is a schematic block diagram of a gyro sensor system according to an exemplary embodiment of the present invention;

FIG. 5 is a schematic block diagram of a gyro sensor system according to another exemplary embodiment of the present invention;

FIG. 6 is a graph illustrating a signal by offset of a gyro sensor;

FIG. 7 is a flowchart schematically illustrating a method for automatically correcting offset of a gyro sensor according to an exemplary embodiment of the present invention; and

FIG. 8 is a flowchart schematically illustrating a method for automatically correcting offset of a gyro sensor according to another exemplary embodiment of the present invention.

### DESCRIPTION OF THE PREFERRED EMBODIMENTS

Exemplary embodiments of the present invention for accomplishing the above-mentioned objects will be described with reference to the accompanying drawings. In describing exemplary embodiments of the present invention, the same reference numerals will be used to describe the same components and an additional description that is overlapped or allow the meaning of the present invention to be restrictively interpreted will be omitted.

In the specification, it will be understood that unless a term such as ‘directly’ is not used in a connection, coupling, or disposition relationship between one component and another component, one component may be ‘directly connected to’, ‘directly coupled to’ or ‘directly disposed to’ another element or be connected to, coupled to, or disposed to another element, having the other element intervening therebetween. In addition, this may also be applied to terms including the meaning of contact such as ‘on’, ‘above’, ‘below’, ‘under’, or the like. In the case in which a standard element is upset or is changed in a direction, terms related to a direction may be interpreted to including a relative direction concept.

Although a singular form is used in the present description, it may include a plural form as long as it is opposite to the concept of the present invention and is not contradictory in view of interpretation or is used as clearly different meaning. It should be understood that “include”, “have”, “comprise”, “be configured to include”, and the like, used in the present description do not exclude presence or addition of one or more other characteristic, component, or a combination thereof.

First, a gyro sensor offset automatic correcting circuit according to a first exemplary embodiment of the present invention will be described in detail with reference to the accompanying drawings. In this case, reference numerals which are not shown in reference drawings may be reference numerals in other drawings showing the same components.

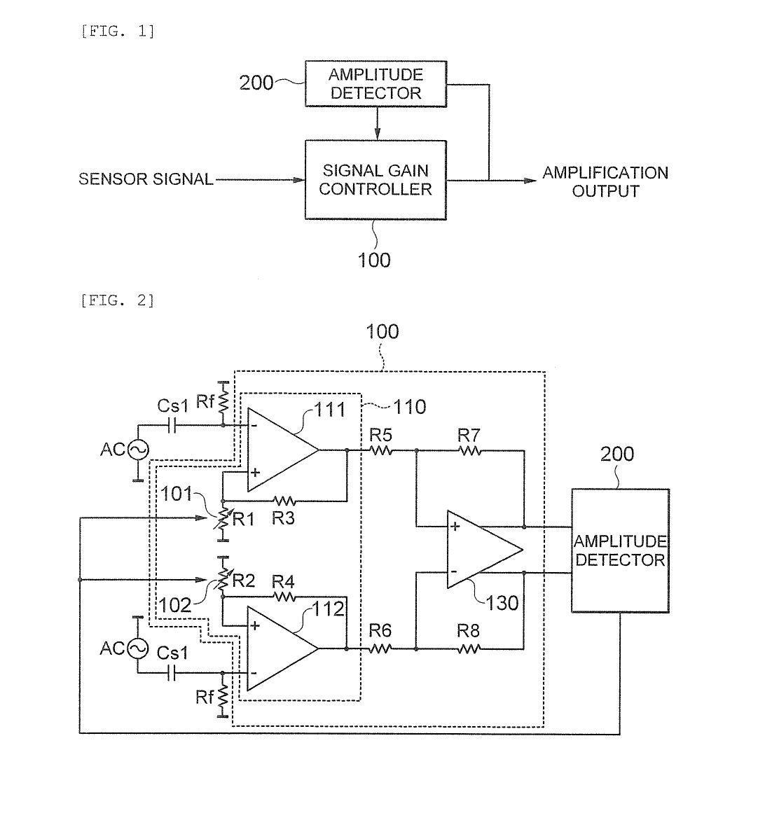

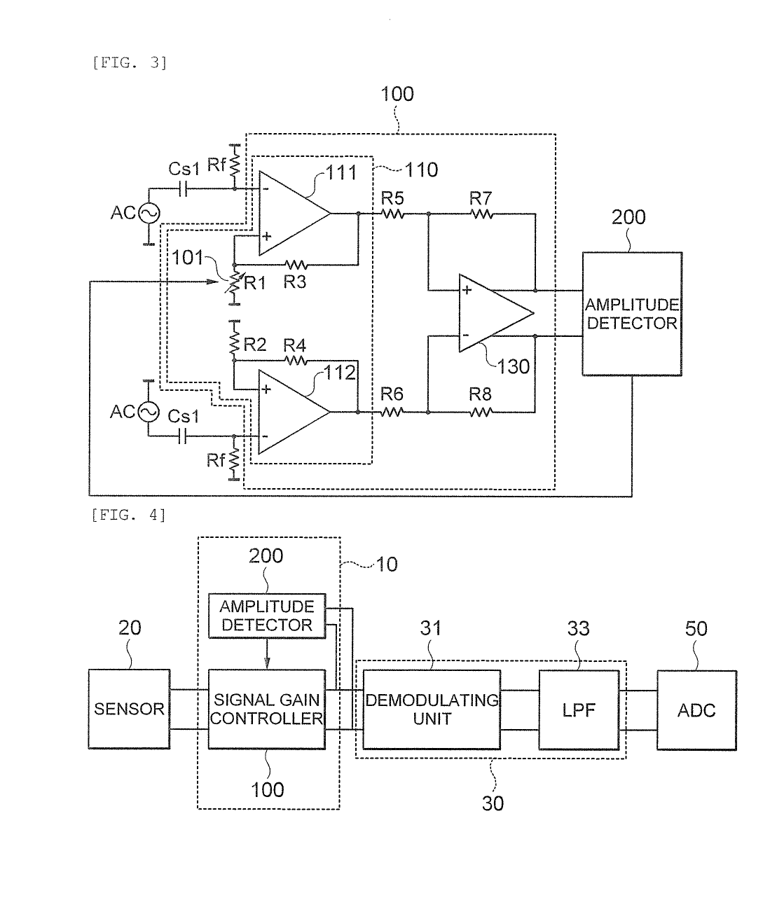

FIG. 1 is a schematic block diagram of a gyro sensor offset automatic correcting circuit according to an exemplary embodiment of the present invention. FIG. 2 is a schematic circuit diagram of a gyro sensor offset automatic correcting circuit according to an exemplary embodiment of the present invention. FIG. 3 is a schematic circuit diagram of a gyro sensor offset automatic correcting circuit according to another exemplary embodiment of the present invention. FIG. 6 is a graph illustrating a signal by offset of a gyro sensor.

Referring to FIG. 1, a gyro sensor offset automatic correcting circuit according to a first exemplary embodiment of the present invention includes a signal gain controller 100 and an amplitude detector 200.

First, referring to FIGS. 1 to 3, the signal gain controller 100 will be described. The signal gain controller 100 of FIG. 1 receives and amplifies output signals of each sensor electrode. In this case, the signal gain controller 100 amplifies the output signal to remove at least some of offset by a driving signal component included in each output signal by controlling a variable resistor. That is, at least some of offset by the driving signal component is removed so as to prevent the signal amplified and outputted in the signal gain controller 100 from being saturated.

A reason for removing or reducing the offset by the driving signal component included in the output signal of the sensor as described in the exemplary embodiment will be described.

A driving signal of a gyro sensor 20 occupies a substantial part of an output of the sensor. In the vibrating gyro sensor 20, the driving signal is generally phase-delayed by 90° to be displayed as the sensor output and a gyro signal is presented as the product of a gyro's unique frequency and the driving signal. In FIG. 6, a phase of an input signal of a differential amplifier (see reference numeral 130 of FIGS. 2 and 3) is phase-delayed from the driving signal by 90°. The input signal of the differential amplifier shown in FIG. 6 represents the signal by the driving signal component. Since the gyro signal is much larger than the driving signal in the sensor output signal, the gyro signal needs to remain while the driving signal is removed. If the sensor is ideal, the driving signal is an in-phase signal and the gyro signal is a differential signal, and as a result, only the gyro signal should remain when passing through the differential amplifier 130. However, a capacitor component Cs of the sensor is not the same for each sensor and has an error of 10% or more to the maximum, and as a result, AC offset occurs when passing through the differential amplifier 130. Referring to FIG. 6, the offset by the driving signal component of the input signal of the differential amplifier is shown. In this case, as shown in FIG. 6, the offset by the driving signal component has an amplification gain in the differential amplifier (see reference numeral 130 of FIGS. 2 and 3) and is represented as an AC offset-gain. If the gain of the differential amplifier 130 is large, a signal, i.e., an AC offset-gain output signal of the differential amplifier (see reference numeral 130 of FIGS. 2 and 3) in FIG. 6 may be saturated by AC offset. In this case, the magnitude of the driving signal should be maximally similar before passing through the differential amplifier 130 so as to prevent the signal depending on the amplification of the output signal from being saturated. In the exemplary embodiment, the magnitude of the driving signal should be maximally similar by controlling the variable resistor in order to prevent saturation depending on the amplification of the output signal.

In this case, if a trimming method by connecting a capacitor by controlling the signal gain of the sensor is adopted, the magnitude of the driving signal may be similarly adjusted by controlling the connected capacitor differently, but a capacitor value varies and a phase of a transferred signal varies by the connected capacitor, and as a result, the phases are deviated from each other. As a result, a phase of the gyro signal may be deviated.

Accordingly, in the exemplary embodiment, the magnitude of the driving signal of the sensor output is maximally similar by controlling the gain of the sensor by using the variable resistor(s).

According to one example, a sensor electrode may be an electrode of a piezoelectric type or capacitive type vibrating gyro sensor 20.

Further in one example, variable resistor(s) 101 or/and 102 may be variable resistor(s) using switches, which can be digitally trimmed.

Referring to FIGS. 2 and/or 3, in one example, the signal gain controller 100 may include a gain adjusting unit 110 and a differential amplifying unit 130.

Referring to FIGS. 2 and/or 3, the gain adjusting unit 110 of the signal gain controller 100 receives the output signals of each sensor electrode to amplify the output signal so as to have gains adjusted by controlling the variable resistor(s) 101 or/and 102. The gains adjusted by controlling the variable resistor(s) 101 or/and 102 are provided to minimize the magnitude of the driving signal component through a subsequent differential amplification process by adjusting the magnitude of the driving signal component to be the same or substantially the same as each other. That is, the gains are adjusted by controlling the variable resistor(s) 101 or/and 102 to remove or reduce the offset of the driving signal component caused due to a difference in value of the capacitor of each sensor element through the subsequent differential amplification process.

Referring to FIGS. 2 and/or 3, in one example, the gain adjusting unit 110 may include first and second gain amplifiers 111 and 112 that receive the output signal of the sensor electrode through inverted terminals, respectively. In this case, the first and second gain amplifiers 111 and 112 take the gains by the variable resistors 101 and 102 differently from each other or only one of the first and second gain amplifiers 111 and 112 takes the gain by the variable resistor 101 to make the magnitudes of the driving signal components to be substantially the same as each other. In the method of adjusting the gain depending on the variable resistors 101 and 102, no capacitor is used, and as a result, there is no possibility that the phase will be deviated unlike the method of reducing the offset by the difference in capacitor in the sensor itself by connecting and trimming the capacitor. Meanwhile, by implementing the variable resistors 101 and 102 by using the switches, digital trimming through switching may be achieved.

For example, in one example, referring to FIG. 2, the first and second gain amplifiers 111 and 112 may perform non-inversion amplification with respect to the output signal of the sensor electrode depending on the variable resistors 101 and 102 connected to non-inversion terminals. In this case, the variable resistors R1 and R2 101 and 102 may be connected to the non-inversion terminals of the first and second gain amplifiers 111 and 112, respectively. The gain may be adjusted by controlling each of the variable resistors R1 and R2 101 and 102 or any one of the variable resistors 101 or 102. The magnitude of the driving signal component is the same or substantially the same as each other by the adjusting the gain to substantially remove or minimize the driving signal component through the subsequent differential amplification process, and as a result, an amplification gain can be increased.

In FIG. 2, referring to the first gain amplifier 111, since the first gain amplifier 111 performs non-inversion amplification, the gain is 1+R3/R1 and for example, a signal of 1 which is a basic gain may be acquired even though all switches constituting the variable resistor R1 101 are turned off. In this case, a signal of the larger output of outputs of the first gain amplifier 111 and the second gain amplifier 112 is fixed and a signal of the smaller output is increased to adjust the magnitudes of amplitudes to be the same or substantially the same as each other.

Further, referring to FIG. 3, in another example, the first and second gain amplifiers 111 and 112 perform non-inversion amplification of the output signals of the sensor electrodes, while the variable resistor 101 is connected to the non-inversion terminal of at least any one of the first and second gain amplifiers 111 and 112. In FIG. 3, the magnitudes of the amplitudes the output signals of the first gain amplifier 111 and the second gain amplifier 112 may be adjusted to be the same or substantially the same as each other by controlling the variable resistor R1 101 connected to the non-inversion terminal of the first gain amplifier 111.

In FIGS. 2 and 3, resistors R3 and R4, R5 and R6, or R7 and R8 may be resistors having the same magnitude.

Further, referring to FIGS. 2 and/or 3, the differential amplifier 130 receives the output of the gain adjusting unit 110 to differentially amplify the received output so as to remove at least some of the offset by the driving signal component. The magnitudes of the driving signals of the sensor outputs are maximally similar to each other by controlling the variable resistor(s) 101 or/and 102 in the signal gain controller 100 in advance to remove or minimize the driving signal in the different amplifier 130. As a result, the amplification gain of the differential amplifier 130 can be increased, and as a result, the SNR is implemented to be higher than that in the case of amplification at the rear of the gyro sensor system and the sensitivity can be increased. Further, by remarkably reducing the AC offset component in advance, the DC offset processing can be maximally reduced at the rear of the gyro sensor system and current consumption by a current controlled digital to analog converter (IDAC) can be remarkably reduced.

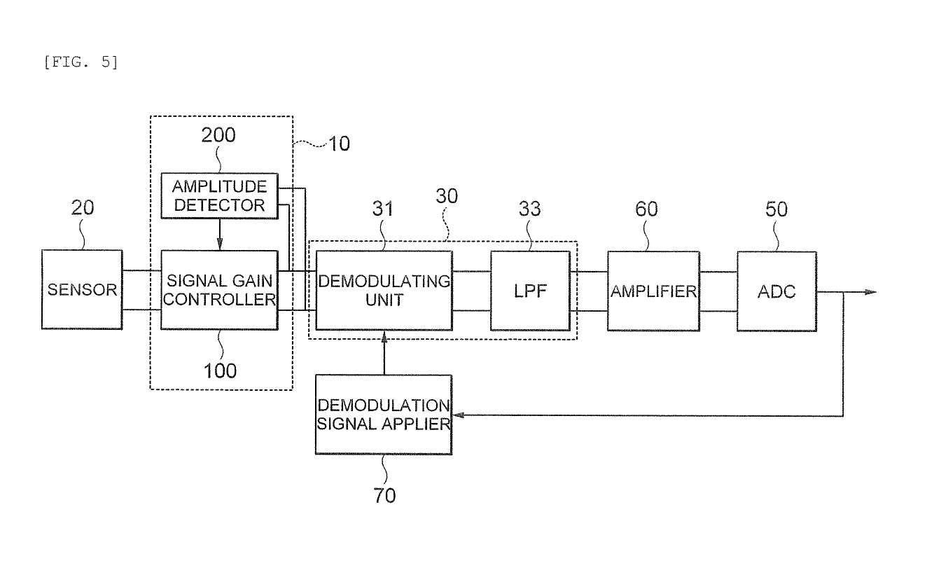

Further, referring to FIGS. 4 and/or 5, in one example, the signal gain controller 100 may transmit the amplified signal to an analog signal processor 30. In this case, the analog signal processor 30 may separate the gyro signal component and the driving signal component from the signal outputted from the signal gain controller 100 and remove the driving signal component. For example, a remaining driving signal of which offset is minimized by controlling the variable resistor(s) 101 or/and 102 in the signal gain controller 100 is removed while passing through the analog signal processor 30, e.g., a demodulating unit (demodulator) 31 and a filter in FIGS. 4 and/or 5 and only the gyro signal remains, and as a result, a final output signal can be controlled no to be saturated.

In the exemplary embodiment, the SNR and/or sensitivity can be increased and the current consumption can be reduced by maximally reducing the offset of the driving signal before removing the driving signal component in the analog signal processor 30 of the gyro sensor system.

Next, the amplitude detector 200 will be described. The amplitude detector 200 of FIG. 1 detects the output signal of the signal gain controller 100 to controls the variable resistors 101 and 102 so that the output signal of the signal gain controller 100 maintains a predetermined range. In this case, the predetermined range may be set to a level at which the signal is not saturated. That is, the range may be set to output signal within a linear output voltage range of the differential amplifier 130. If the value detected in the amplitude detector 200 deviates from an allowable range, for example, the output signal may be swept to be included in the allowable range level by controlling the variable resistor(s) 101 or/and 102 constituted by the switches by increasing digital values sequentially.

Further, although not shown, according to one example, the amplitude detector 200 may include a comparator (not shown). The amplitude detector 200 may generate a signal for controlling the variable resistors 101 and 102 so that the output signal of the signal gain controller 100 is maintained with the predetermined range when the output signal of the signal gain controller 100 is equal to or more than a predetermined first level or equal to or less than a predetermined second level through the comparator. That is, the variable resistors 101 and 102 are controlled so as to prevent the output signal from being saturated.

In this case, in one example, the amplitude detector 200 may include a comparator (not shown) comparing the output signal of the signal gain controller 100 and the first level or the second level and a variable resistor controller (not shown) generating a signal for controlling the variable resistors 101 and 102 according to the output of the comparator. In this case, the variable resistors 101 and 102 may be implemented by using the switch to be digitally trimmed.

In the gain trimming method according to the exemplary embodiment of the present invention, the amplification ratio can be implemented to be high at the front of the gyro sensor system, and as a result, the SNR can be more highly implemented than the case of amplification at the rear of the gyro sensor system. Further, as a result, the sensitivity can be increased. Moreover, since the AC offset component is remarkably reduced at the front of the gyro sensor system, the DC offset processing can be maximally reduced at the rear of the gyro sensor system, and as a result, the current consumption by the IDAC can be remarkably reduced.

Next, a gyro sensor system according to a second exemplary embodiment of the present invention will be described in detail with reference to the accompanying drawings. In describing the exemplary embodiment, the gyro sensor offset automatic correcting circuit according to the first exemplary embodiment and FIGS. 1 to 3 will be referenced in addition to FIGS. 4 and 5, and as a result, duplicated description may be omitted.

FIG. 4 is a schematic block diagram of a gyro sensor system according to an exemplary embodiment of the present invention. FIG. 5 is a schematic block diagram of a gyro sensor system according to another exemplary embodiment of the present invention.

Referring to FIG. 4, the gyro sensor system according to the second exemplary embodiment of the present invention includes a gyro sensor 20, a gyro sensor offset automatic correcting circuit 10, an analog signal processor 30, and an analog-to-digital converter 50. Referring to FIG. 5, the gyro sensor system may further includes an amplifier 60 between the analog signal processor 30 and the analog-to-digital converter 50 and the gyro sensor system may further include a demodulation signal applier 70 applying a demodulation signal to the analog signal processor 30.

More specifically, the gyro sensor 20 of FIGS. 4 and/or 5 receives a driving signal to output sensor signals depending on movement of an objective through a plurality of sensor electrodes. The gyro sensor 20 receives the driving signal to output a signal in which the driving signal and the gyro signal are mixed. Since the driving signal is much larger than the gyro signal in the sensor output signal, the amplification gain can be increased and the sensitivity of the sensor can be increased by removing the driving signal and leaving only the gyro signal. Therefore, in order to increase the amplification gain without saturation, the magnitudes of the driving signals are adjusted to be maximally similar to each other and pass through the different amplifier 130 to minimize the offset by the driving signal. To this end, the gyro sensor offset automatic correcting circuit 10 to be described below is provided.

Next, in FIGS. 4 and/or 5, the gyro sensor offset automatic correcting circuit 10 receives and amplifies the output signals of each sensor electrode of the gyro sensor 20, while outputting the output signal within a predetermined range. In this case, the gyro sensor offset automatic correcting circuit 10 may follow any one of the first exemplary embodiments. The gyro sensor offset automatic correcting circuit 10 according to FIGS. 1, 2, and/or 3 may be applied to FIGS. 4 and/or 5. The gyro sensor offset automatic correcting circuit 10 will be described with reference to the first exemplary embodiment.

Continuously, referring to FIGS. 4 and/or 5, the analog signal processor 30 receives the output signal of the signal gain controller 100 of the offset automatic correcting circuit 10 to separate the gyro signal component and remove the driving signal component. The output signal of the gyro sensor 20 is the signal in which the driving signal and the gyro signal are mixed and is differentially amplified by adjusting the magnitudes of the driving signals to be maximally similar to each other while passing through the signal gain controller 100 of the gyro sensor offset automatic correcting circuit 10 to minimize the driving signal component, but the remaining driving signal component needs to be removed. In this case, the remaining driving signal component is removed in the analog signal processor 30.

More specifically, referring to FIGS. 4 and/or 5, in one example, the analog signal processor 30 may include a demodulator 31 and a low-pass filter 33. The gyro sensor 20 itself serves as a modulator and outputs the signal in which the driving signal and the gyro signal are mixed. In this case, the demodulator 31 separating the driving signal and the gyro signal from the output signal is required.

In this case, the demodulator 31 receives the output signal of the signal gain controller 100 of the offset automatic correcting circuit 10 to separate the driving signal component and the gyro signal component. The signal is differentially amplified by adjusting the magnitudes of the driving signals to be maximally similar to each other in the signal gain controller 100 to minimize the driving signal component, but the driving signal component remains or may remain, and as a result, the driving signal component and the gyro signal component are separated from each other in the demodulator 31 in order to remove the remaining driving signal component.

A process of separating the driving signal component and the gyro signal component will be described below. The driving signal component and the gyro signal component are mixed in a signal applied to the demodulator 31 as the output signal of the gyro sensor 20 and in general, the gyro signal component is earlier than the driving signal component by a phase of 90°. In this case, when a pulse signal having the same phase as the gyro signal component is applied as a demodulation signal, the driving signal component is demodulated by the demodulation signal and when the driving signal component is averaged, the driving signal component is averaged to reference voltage Vref. On the contrary, when the gyro signal component is demodulated and averaged by the demodulation signal, the gyro signal component has a predetermined value slightly spaced from the reference voltage Vref. In this case, the driving signal component may be removed through the low-pass filter 33. In this case, the demodulation signal has a phase earlier than the driving signal component of the sensor output by 90°.

Referring to FIGS. 4 and/or 5, the low-pass filter 33 removes the driving signal component separated from the demodulator 31. As a result, finally, the driving signal is removed and only the gyro signal remains.

Meanwhile, referring to FIG. 5, in another example, the gyro sensor system may further include an amplifier 60. In this case, the amplifier 60 is placed between the analog signal processor 30 and the analog-to-digital converter 50 and amplifies the gyro signal component separated in the analog signal processor 30.

Further, referring to FIG. 5, in one example, the gyro sensor system may further include a demodulation signal applier 70. In FIG. 5, the demodulation signal applier 70 applies the demodulation signal for separating the gyro signal in the analog signal processor 30 to the analog signal processor 30. As described above, in this case, the demodulation signal applied by the demodulation signal applier 70, that is, the demodulation signal has a phase earlier than the driving signal component of the sensor output by 90°. Meanwhile, since the driving signal applied to the gyro sensor 20 is phase-delayed by 90° as the driving signal component of the sensor output, the demodulation signal applied by the demodulation signal applier 70, that is, the demodulation signal may be a signal having the same phase as the driving signal applied to the gyro sensor 20.

Next, the analog-to-digital converter 50 converts the gyro signal separated in the analog signal processor 30 into a digital signal.

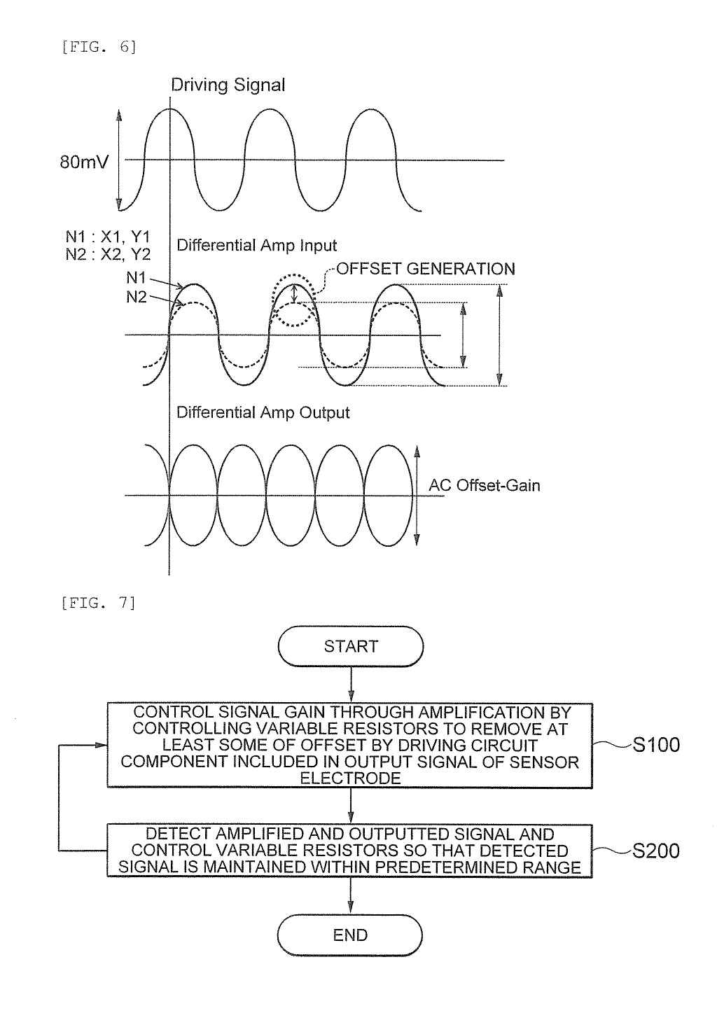

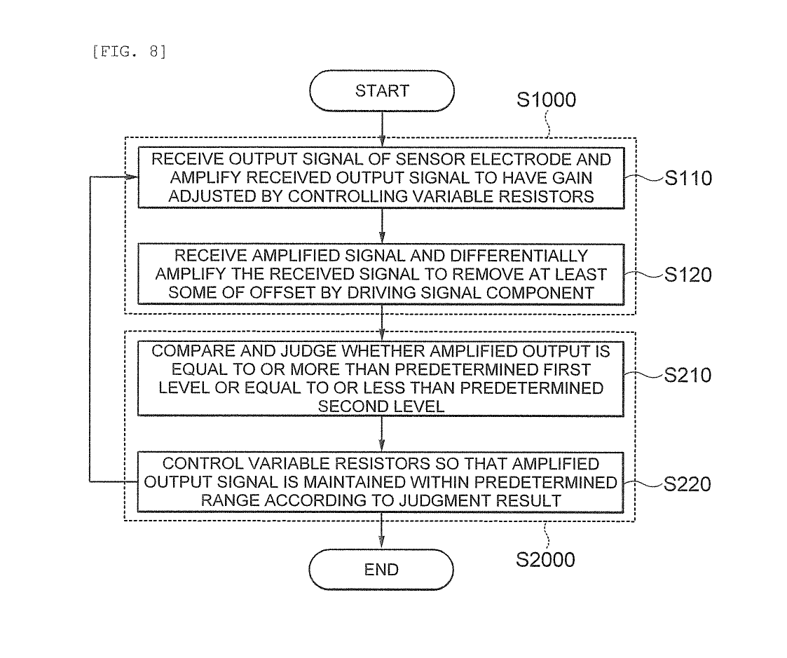

Next, a method for automatically correcting offset of a gyro sensor according to a third exemplary embodiment of the present invention will be described in detail with reference to the accompanying drawings. In describing the exemplary embodiment, the gyro sensor offset automatic correcting circuit according to the first exemplary embodiment and FIGS. 1 to 3 will be reference in addition to FIGS. 7 and 8, and as a result, duplicated description may be omitted.

FIG. 7 is a flowchart schematically illustrating a method for automatically correcting offset of a gyro sensor according to an exemplary embodiment of the present invention. FIG. 8 is a flowchart schematically illustrating a method for automatically correcting offset of a gyro sensor according to another exemplary embodiment of the present invention.

Referring to FIG. 7, the method for automatically correcting offset of a gyro sensor according to the third exemplary embodiment of the present invention may include controlling a signal gain (S100) and controlling variable resistors (S200).

Referring to FIG. 7, in the controlling of the signal gain (S100), output signals of each sensor electrode is received and amplified. In this case, the signal gain is controlled to remove at least some of offset by a driving signal component included in each output signal by controlling variable resistor 101 and 102.

More specifically, referring to FIG. 8, in another example, the controlling of the signal gain (S100) may include amplifying the gain (S110) and differential amplifying (S120).

Referring to FIG. 8, in the amplifying of the gain (S110), the gain is amplified to have a gain adjusted by controlling the variable resistor(s) 101 or/and 102 by receiving the output signals of each sensor electrode.

In this case, referring to FIG. 2, in one example, in the amplifying of the gain (S110), non-inversion amplification of the output signals of the sensor electrodes may be performed depending on the variable resistors 101 and 102 connected to non-inversion terminals by the first and second gain amplifiers 111 and 112 receiving the output signals of the sensor electrodes through inversion terminals.

Further, in another example by referring to FIG. 3, in the amplifying of the gain (S110), the non-inversion amplification of the output signals of the sensor electrodes are performed by the first and second gain amplifiers 111 and 112 receiving the output signals of the sensor electrodes, while the variable resistor 101 is connected to the non-inversion terminal of any one of the first and second gain amplifiers 111 and 112.

Further, referring to FIG. 8, in the differential amplifying (S120), the signal amplified in the amplifying of the gain (S110) is received to be differentially amplified to remove at least some of the offset by the driving signal component.

Although not shown, referring to the analog signal processor 30 of FIGS. 4 and/or 5, in one example, separating the gyro signal component from the signal amplified and removing the driving signal component (not shown) in the controlling of the signal gain (S100) may be further included.

In the controlling of the variable resistors of FIG. 7 (S200), a signal amplified and outputted in the controlling of the signal gain (S100) is detected and the variable resistors 101 and 102 are controlled so that the detected output signal is maintained within a predetermined range.

Referring to FIG. 8, the controlling of the variable resistors (S200) will be described in more detail.

Referring to FIG. 8, in one example, in the controlling of the variable resistors (S200), whether the output signal from the controlling of the signal gain (S100) is equal to or more than a predetermined first level or equal to or less than a predetermined second level (S210) is judged by a comparator (not shown) and a signal for controlling the variable resistors 101 and 102 may be generated so that the output signal from the controlling of the signal gain (S100) is maintained within the predetermined range according to the judgment result (S220).

As set forth above, according to the exemplary embodiments of the present invention, a driving signal component included in a sensor output can be removed or minimized by adjusting the magnitude of a driving signal to be maximally similar in order to prevent saturation depending on amplification of an output signal of a sensor.

Further, according to the exemplary embodiments of the present invention, an amplification ratio can be implemented highly at a front of a gyro sensor system by controlling a variable resistor, and as a result, an SNR can be more highly implemented than a case in which the amplification ratio is implemented at a rear. As a result, sensitivity can be increased.

Moreover, according to the exemplary embodiments of the present invention, since an AC offset component is remarkably reduced at the front of the gyro sensor system, DC offset processing can be maximally reduced the rear of the gyro sensor system, and as a result, current consumption by an IDAC can be remarkably reduced.

The accompanying drawings and the above-mentioned exemplary embodiments have been illustratively provided in order to assist in understanding of those skilled in the art to which the present invention pertains rather than limiting a scope of the present invention. In addition, exemplary embodiments according to a combination of the above-mentioned configurations may be obviously implemented by those skilled in the art. Therefore, various exemplary embodiments of the present invention may be implemented in modified forms without departing from an essential feature of the present invention. In addition, a scope of the present invention should be interpreted according to claims and includes various modifications, alterations, and equivalences made by those skilled in the art.

What is claimed is:

1. A gyro sensor offset automatic correcting circuit, comprising:
a signal gain controller receiving and amplifying output signals of each sensor electrode, while removing at least some of offset by a driving signal component included in each output signal by controlling a variable resistor(s); and
an amplitude detector detecting the output signal of the signal gain controller to control the variable resistor(s) so that the output signal of the signal gain controller is maintained within a predetermined range.

2. The gyro sensor offset automatic correcting circuit according to claim 1, wherein the signal gain controller includes:
a gain adjusting unit receiving the output signals of each sensor electrode and amplifying the received output signal to have a gain adjusted by controlling the variable resistor(s); and
a differential amplifying unit receiving the output of the gain adjusting unit and differentially amplifying the received output to remove at least some of the offset by the driving signal component.

3. The gyro sensor offset automatic correcting circuit according to claim 2, wherein the gain adjusting unit includes first and second gain amplifiers receiving the output signals of each sensor electrode through inversion terminals, and
the first and second gain amplifiers perform non-inversion amplification of the output signals of each sensor electrode according to the variable resistors connected to non-inversion terminals.

4. The gyro sensor offset automatic correcting circuit according to claim 2, wherein the gain adjusting unit includes first and second gain amplifiers receiving the output signals of each sensor electrode through the inversion terminals, and
the first and second gain amplifiers perform non-inversion amplification of the output signals of the sensor electrodes, while the variable resistor is connected to the non-inversion terminal of any one of the first and second gain amplifiers.

5. The gyro sensor offset automatic correcting circuit according to claim 1, wherein the variable resistor(s) is a variable resistor(s) using switches which are digitally trimmable.

6. The gyro sensor offset automatic correcting circuit according to claim 1, wherein the amplitude detector includes a comparator and when the output signal of the signal gain controller is equal to or more than a predetermined first level or equal to or less than a predetermined second level, the amplitude detector generates a signal for controlling the variable resistor(s) so that the output signal of the signal gain controller is maintained within the predetermined range.

7. The gyro sensor offset automatic correcting circuit according to claim 6, wherein the amplitude detector includes:
the comparator comparing the output signal of the signal gain controller with the first level or the second level; and
a variable resistor controlling unit generating the signal for controlling the variable resistor(s) in accordance with the output of the comparator.

8. The gyro sensor offset automatic correcting circuit according to claim 1, wherein the sensor electrode is an electrode of a piezoelectric type or capacitive type vibrating gyro sensor.

9. The gyro sensor offset automatic correcting circuit according to claim 1, wherein the signal gain controller transmits the amplified signal to an analog signal processor that separates a gyro signal component and removes the driving signal component.

10. A gyro sensor system, comprising:
a gyro sensor outputting sensor signals depending on movement of an objective through a plurality of sensor electrodes by receiving a driving signal;
the gyro sensor offset automatic correcting circuit according to claim 1, receiving and amplifying output signals of each sensor electrode of the gyro sensor, while outputting an output signal within a predetermined range;
an analog signal processor separating a gyro signal component and removing a driving signal component by receiving an output of a signal gain controller of the offset automatic correcting circuit; and
an analog-to-digital converter converting the gyro signal separated in the analog signal processor into a digital signal.

11. The gyro sensor system according to claim 10, further comprising:
an amplifier amplifying the gyro signal component separated in the analog signal processor between the analog signal processor and the analog-to-digital converter.

12. The gyro sensor system according to claim 10, wherein the analog signal processor includes:
a demodulator separating the driving signal component and the gyro signal component by receiving the output signal of the signal gain controller of the offset automatic correcting circuit; and
a low-pass filter removing the driving signal component separated in the demodulator.

13. The gyro sensor system according to claim 10, further comprising a demodulation signal applier applying a demodulation signal for separating the gyro signal in the analog signal processor to the analog signal processor.

14. A method for automatically correcting offset of a gyro sensor, comprising:
controlling a signal gain to remove at least some of offset by a driving signal component included in each output signal by controlling a variable resistor(s), while receiving and amplifying the output signals of each sensor electrode; and
controlling the variable resistor(s) so that the detected output signal is maintained within a predetermined range by detecting the signal amplified and outputted in the controlling of the signal gain.

15. The method for automatically correcting offset of a gyro sensor according to claim 14, wherein the controlling of the signal gain includes:
amplifying a gain to have a gain adjusted by controlling the variable resistor(s) by receiving the output signals of each sensor electrode; and
receiving a signal amplified in the amplifying of the gain and differentially amplifying the received signal to remove at least some of the offset by the driving signal component.

16. The method for automatically correcting offset of a gyro sensor according to claim 15, wherein in the amplifying of the gain, non-inversion amplification of the output signals of each sensor electrode is performed in accordance with the variable resistors connected to non-inversion terminals by first and second gain amplifiers receiving the output signals of the sensor electrodes through inversion terminals.

17. The method for automatically correcting offset of a gyro sensor according to claim 15, wherein in the amplifying of the gain, non-inversion amplification of the output signals of each sensor electrode is performed by the first and second gain amplifiers receiving the output signal of the sensor electrode through the inversion terminals, while the variable resistor is connected to a non-inversion terminal of any one of the first and second gain amplifiers.

18. The method for automatically correcting offset of a gyro sensor according to claim 14, wherein in the controlling of the variable resistor(s), whether the output signal from the controlling of the signal gain is equal to or more than a predetermined first level or equal to or less than a predetermined second level is judged by a comparator and a signal for controlling the variable resistor(s) is generated according to the judgment result so that the output signal from the controlling of the signal gain is maintained within the predetermined range.

19. The method for automatically correcting offset of a gyro sensor according to claim 14, further comprising separating a gyro signal component from the signal amplified in the controlling of the signal gain and removing the driving signal component.
